(19) United States
(12) Patent Application Publication
(10) Pub. No.: US 2005/0194424 A1
(43) Pub. Date: Sep. 8, 2005

(54) Apparatus and method for sonic welding and materials forming

(76) Inventor: William Harvey Sproat, Cartersville, GA (US)

Correspondence Address: William H. Sproat, 192 Ridgeview Trail SE, Cartersville, GA, 30120, US

(21) Appl. No.: 10/792,304

(22) Filed: Mar. 3, 2004

(51) Int. Cl. B23K 1/00

(52) U.S. Cl. 228/115

(57) ABSTRACT

This invention comprises an apparatus and method for sonic welding and materials forming by superposition of high-power-density sonic shear wave and sonic compression wave impulses directed by a sonic lens into a workpiece. The shear impulse is induced by refraction and mode conversion of a compression impulse. Materials subjected to shear impulses are transformed from solid-to-viscoelastic state. The compression impulse is superimposed on the shear impulse. Welding is effected by shear induced viscoelasticity, combined with quasistatic and dynamic compressive stress, at interfaces among workpiece elements. Further, superimposed shear and compression impulses are applied to fuse, shape, and transform materials. The apparatus functions with a range of energy sources. The shear impulse is partitioned from the compression impulse. Waveguide may be applied for impedance matching among the energy sources, sonic lenses, and workpiece. The present invention relates to solid state welding, materials forming, fusion, cohesion, adhesion, and substructure modification.

### CROSS REFERENCE TO RELATED APPLICATIONS

U.S. Patent Documents

| | | | |
|---|---|---|---|
| 4,780,867 | October 1988 | Lind, et al | 369/100. |
| 4,899,030 | February 1990 | Miyazaki | 219/121. |
| 5,104,027 | April 1992 | Persson | 228/107. |
| 6,548,792 | April 2003 | Durand | 219/617. |
| 6,571,593 | June 2003 | Chung, et al. | 72/262 |

Foreign Patents

| | | | |
|---|---|---|---|
| US3702674 | November 1972 | Bodine | B23K1/06 |

### STATEMENT REGARDING FEDERALLY SPONSORED RESEARCH OF DEVELOPMENT

Not Applicable

### DESCRIPTION OF ATTACHED APPENDIX

Disclosure of Invention “High Energy Pulse (HEP) Welding”, dated 3 Sep. 2003

1. Background of the Invention

The term sonic, for purposes of this invention, is defined as a wave-like oscillation of matter induced by either a stress impulse or cyclic stress. The terms wave and impulse are interchangeable within the context of illustration and description of this invention. The term impulse is intended to convey the meaning of a transient sonic event; multiple impulses means repeated transient sonic events. Wave modes described in this invention are the following: compression or longitudinal, wherein oscillations are along the direction of travel or propagation, and shear or transverse, wherein oscillations are at a right angle to the direction of travel or propagation.

Mode conversion is the transformation of compression oscillations in one sonic wave propagating medium, impinging at an angle at the interface with a second sonic wave propagating medium, wherein shear oscillations are exhibited in the second medium. In general, the shear mode of propagation is supported by solid materials exhibiting linear elastic shear behavior. In particular, high rates of shear, induced by impulse transients, result in a nonlinear dynamic shear behavior of materials characterized as non-Newtonian viscoelastic. For sake of convenience in this document, the term viscoelastic implies non-Newtonian behavior. The shear mode of propagation terminates in the viscoelastic medium, expending its energy in material change-of-state from linear elastic to viscoelastic.

When a compression mode impulse is superposed on a volume of viscoelastic material, rapid displacement of the material takes place in response to transient compression stress. This invention applies sonic lens, including both transmitter and reflector configurations, to attain high-power-density; i.e., high-rate of energy transfer within a confined volume of material, by superposing compression and shear impulses.

Waveguides, impulse transit delay lines, resonant elements, and sonic impedance transformers are also inherent features of the apparatus disclosed herein. Said features apply basic underlying principles of sonic wave behavior and are not unique to the description and claims exhibited in the disclosure of this invention.

In this disclosure: fusion is cohesive joining of contiguous materials, welding is a process of fusion by dispersion of cohesive inhibiting substances, adhesion is the bonding of contiguous dissimilar materials by molecular attraction, and materials forming is a process of deformation and substructure modification.

2. Prior Art

This invention relates generally to the field of solid state welding and materials forming, and more specifically to an apparatus and method of sonic welding, materials forming, and materials substructure modification. The impulse nature of this invention is analogous to explosion welding, wherein materials are joined by driving one element of a subassembly into another with controlled detonation of a shaped charge. The collision of objects has a mechanical impulse character which disrupts inherent metal surface oxides, exposing the base metal to cohesively fuse along contiguous surfaces.

Another similar prior technology is percussion welding in which workpiece elements are joined by heating with an electrical arc between them, followed by repeated compression impulses to induce fusion. Ultrasonic welding is an additional technology with features similar to the present technology. Here, the elements to be fused are subjected to high frequency oscillations in which contiguous surfaces exhibit a thermal fusion behavior arising from mechanical friction at interfaces.

Materials forming features of this invention are similar to a vibrational energy assist to static and quasistatic forming process that reduces the static load required for deformation. It is also similar to electromagnetic pulse induction forming of metals in which induced current creates reactive forces that bear on the workpiece, driving it to conform to a planned shape.

Metals substructure modification aspects of this invention are processes which are similar to conventional thermoelastic and thermoplastic processes; this invention replaces heat with sonically induced viscoelastic behavior.

### BRIEF SUMMARY OF THE INVENTION

One object of this invention is to significantly increase both tensile and shear load properties of joints formed with impulse driven fasteners by introducing an adjunct fusion ring around the fastener. Another object of the invention is to devise a materials joining process which requires very short time intervals, thus affording high through-put rates. Another object of the invention is to integrate the apparatus with existing commercial tools, thus minimizing capital investment. A further object of the invention is minimal unit cost addition to achieve high-value added properties for fastener installations. Yet another object of the invention is the ability to conduct reliable fastening and welding processes with low operator skill requirements.

Yet another object of the invention is to provide a wide range of applicability for materials joining with similar and dissimilar metals, and non-metallics. Another object of this invention is absence of thermal hazards and high intensity light flashes common to conventional arc welding processes. Another object of the invention is to avert residual stress and heat affected zones accompanying conventional thermal welding processes.

A further object of the invention is low tooling costs for materials forming by negating the need for high bearing loads. Yet another object of the invention is elimination of filler metal for metals joining.

Other objects and advantages of the present invention will become apparent from the following descriptions, taken in connection with the accompanying drawings wherein, by way of illustration and example, embodiments of the present invention are disclosed.

In accordance with a preferred embodiment of the invention, there is disclosed an apparatus and method for sonic welding of materials comprising:
superposition of a sonic shear wave impulse and a sonic compression wave impulse converging simultaneously within a workpiece. Said sonic shear wave impulse transforms materials from a solid state to a viscoelastic state. A sonic compression wave impulse, also introduced by said sonic lens, impinges on said materials transformed to a viscoelastic state to induce material displacement.

Said sonic lens, or lenses may be positioned in single or multiple configurations adapted to varying requirements. Said apparatus functions with a range of energy sources, including but not limited to: single or multiple explosive charges, single or multiple mechanical impacts, single or multiple pneumatic impulses, and single or multiple electrodynamically driven impulses.

Said sonic shear wave energy is derived and partitioned from said sonic compression wave impulse through a refraction angle, codependent with inherent sonic wave velocities of said sonic lens and said workpiece. Said sonic lens spatial distribution, shape, and resonance inducing features provide for coincident transit times of said sonic compression wave impulse and said sonic shear wave impulse into said workpiece. Said sonic lens composition and shape are covariable. Said energy source, or sources, may be modulated to optimize sonic power spectral densities in said workpiece. Materials in said apparatus are selected for inherent sonic velocity, resonance, and impedance attributes to attain required impulse transmission, reflection, refraction, and mode conversion properties. Sonic waveguides may be applied for impedance matching among said energy sources, said sonic lens, and said workpiece.

In accordance with a preferred embodiment of the invention, there is disclosed an apparatus and method for sonic deformation, bonding and substructure modification of materials comprising: superposition of a sonic shear wave and a sonic compression wave impulse impinging simultaneously within a workpiece. Said sonic shear wave impulse is introduced into said workpiece through a sonic lens, or lenses, which introduce a high-power density within the body of, or at interfaces among, contiguous elements of said workpiece. Said sonic shear wave impulse transforms materials from a solid state to a viscoelastic state. Said sonic shear wave impulse is induced by a sonic lens which creates a high-shear-power density within the body of said workpiece. Said sonic compression wave impulse applies positive stress on said materials transformed to said viscoelastic state. Said sonic compression wave impulse is induced by said sonic lens which creates a high-compression power density within the body of said workpiece. Said sonic lens is positioned in one or multiple configurations adapted to application requirements. Said apparatus functions with a range of energy sources, including but not limited to: single or multiple explosive charges, single or multiple mechanical impacts, single or multiple pneumatic impulses, and single or multiple electrodynamically driven impulses. Said sonic shear wave energy is derived and partitioned from said sonic compression wave impulse, directed by refraction angles codefendant with inherent sonic wave velocities of said sonic lens and said workpiece Said sonic lens spatial distributions, shape, and resonance inducing features provide for superposition of said sonic compression wave impulse and said sonic shear wave impulse through adjustment of impulse transit time for each said sonic impulse origin. Said sonic lens composition and shape are covariable. Said energy sources may be modulated to generate a desired range of power-spectral-densities. Materials in said apparatus are selected for inherent sonic velocity, resonance, and impedance attributes to attain required impulse transmission, reflection, refraction, and mode conversion properties. Sonic waveguides may be applied for impedance matching among said energy sources, said sonic lens, and said workpiece.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a cross-sectional view of the invention according to the first embodiment. Components in this example are cylindrical sections about a centerline axis. The referenced numeral 21 identifies a ring shaped zone of fusion between two elements of of the workpiece, identified as numeral 22 and numeral 24. The referenced numeral 29 identifies a sonic lens contacting the incident element of the workpiece identified as numeral 22. The referenced numeral 23 identifies a sonic lens contiguous to the opposing surface of the workpiece. The referenced numeral 25 identifies a cartridge containing an explosive charge. Expanding gases from ignition of the explosive charge, confined by the hollow cylinder numeral 26, drive the piston impactor numeral 27 to: firstly, drive a penetrating pin numeral 28, and then simultaneously impact the sonic lens numeral 29 and incident surface of the workpiece.

An impact generated sonic compression impulse is induced in both the workpiece and the sonic lens numeral 29. The sonic compression impulse, incident on the faceted peripheral extremes of sonic lens 29, is refracted into the workpiece as a shear impulse. The compression impulse transmitted through the workpiece is reflected back by the sonic lens 23. This reflected compression impulse is geometrically partitioned into normal incidence and angled incidence on the plane of contact with the workpiece. The angled incidence is such that the compression impulse within lens 23 is refracted into the workpiece as a shear mode. The reflected compression impulse, having normal incidence to the workpiece, remains in the compression mode. A high-power-density superposition of shear and compression impulses induces viscoelastic behavior and material displacement in the workpiece, especially around the pin where the two elements of the workpiece, numerals 22 and 24 are pin restrained. The resultant workpiece fusion zone coincides with the spatial distribution of superimposed shear and compression mode impulses. Fusion is effected in multi-layer workpieces, in addition to the above described two layer case. FIG. 2 is an expanded view of the sonic lenses 29 and 30 and the workpiece 22 and 24. It illustrates the sonic compression and shear mode profiles. The pin is excluded from this depiction for sake of clarity. Downward pointing arrows, illustrated within the body of the piston impactor 27, represent the incident compression impulse. The illustration view on the right half of FIG. 2 exhibits two shear mode profiles, both identified by the letter S, as refracted from compression impulses propagating within the bounds of sonic lenses 29 and 30, into the workpiece. The illustration view on the left half of FIG. 2 shows three reflected compression mode profiles, all identified by the letter C, as propagating within the bounds of lens 23. These compression mode profiles have been geometrically partitioned into both normal and angled incidence on the workpiece by angled facets on the lower extreme of sonic lens 23. The high-power-density arising from superposition of shear and compression mode impulses induces viscoelastic behavior and material displacement in the workpiece. Zones of fusion arise where superimposed shear and compression impulses displace metal oxide surfaces. Parent metal cohesion takes place in a volume of material depicted by the cross-hatched boundaries identified by numeral 21. All components of the apparatus and depictions of shear mode and compression mode profiles described above are shapes of revolution about a centerline axis. For sake of clarity in FIG. 2, shear mode profiles are shown on the right half of the illustration and compression mode profiles are shown on the left half of the illustration.

FIG. 3 depicts views of the second embodiment of this invention, intended to form and cohesively fuse materials, activate adhesive agents among workpiece elements, and modify intrinsic materials substructure. FIG. 3-I is a detailed cross sectional view of a rod shaped sonic lens acting as a forming element numeral 35, along with a matching die numeral 32; which represents the second embodiment of this invention. The view in FIG. 3-I depicts a downward quasistatic load with dashed arrows identified with the letter Q, and an impact on the forming element by downward pointing arrows, along with the internal composition of the sonic lens attributes of the forming element. The lens consists of two different materials, identified by numerals 33 and 34, which act to geometrically partition the impact generated compression impulse into both normal incidence and angled incidence along interfaces common to the workpiece.

FIG. 3-II illustrates, with arrows, two compression impulse directions within the lens. The numeral 36 shows the direction of a compression impulse aimed into the workpiece at normal incidence. The lens compression impulse numeral 37 is refracted at the internal bi-material lens interface, and thence directed at the lens-to-workpiece interface at an angle that induces refracted shear mode propagation within the workpiece. The high-power-density superposition of shear and compression impulses induces viscoelastic materials behavior. Material displacement is driven by both the external quasistatic downward load, depicted by the letter Q in FIG. 3-I, and the compression impulse. The workpiece yields to a relatively low stress in zones where shear and compression modes are superimposed.

The view in FIG. 3-III depicts the next forming stage with direction of one compression impulse numeral 39 directed from bi-material lens refraction. Normal incidence of this sonic compression impulse on the workpiece transmits into the workpiece as compression impulse. Sonic compression impulse numeral 38 is directed at angled incidence on the workpiece to induce a refracted sonic shear impulse within the workpiece. The superposition of shear and compression impulses is in a zone different from that in FIG. 3-II. The workpiece undergoes deformation with continued quasistatic downward load within a second zone of superimposed shear and compression impulses. This two-staged process allows for a more controlled and complex shaping capability than one using a conventional forming processes. Description of this embodiment uses only two forming stages for sake of clarity. Multiple stages are desirable for more complex forms.

The first embodiment as configured in FIG. 4-I, depicts a resonant body 42 interposed between the impactor 27 and the workpiece elements 22 and 24. The resonant body is composed of material with a selected sonic wave velocity, mass and shape to both support a standing wave 42 and transform sonic impedance from the impactor to the workpiece. The schematic depiction in FIG. 4-II shows the resonant compression standing wave impinging on the workpiece. Further, that fraction of the resonant sonic compression wave 42 transmitted through the workpiece is reflected back by lens 23, at a direction C, to refract and convert to a shear mode S within the workpiece. Resonance is sustained for a time period sufficient to permit temporal and spatial coincidence of sonic compression and shear wave modes within the workpiece.

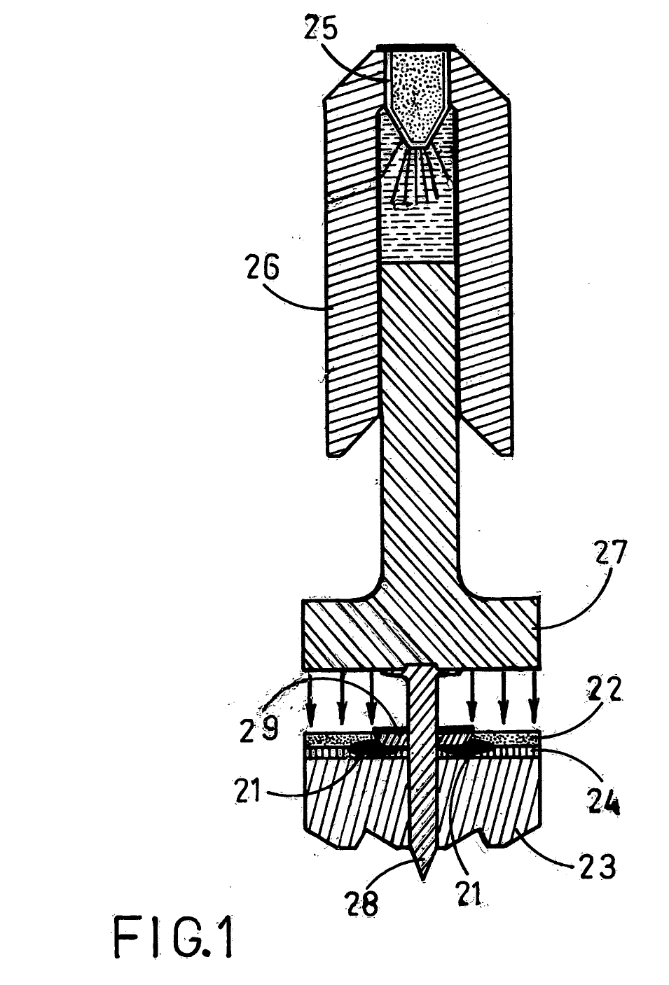

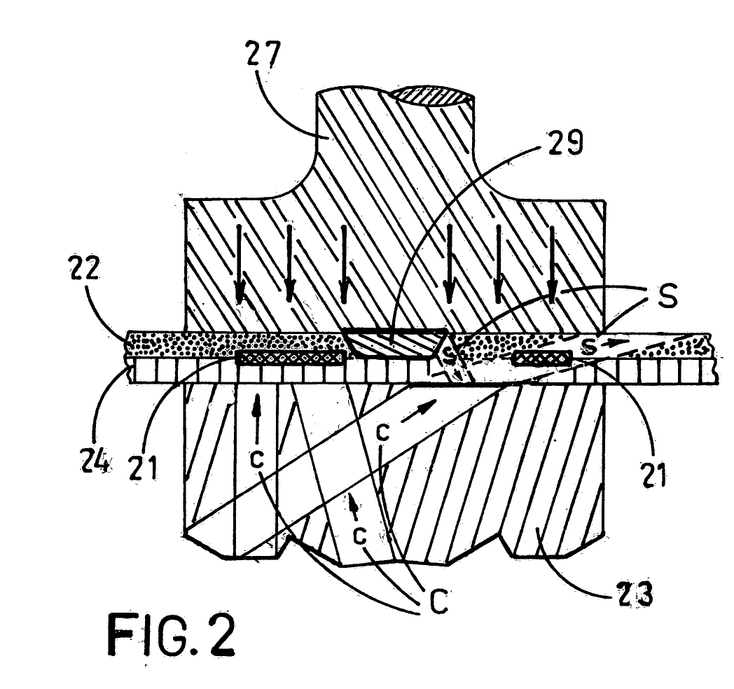

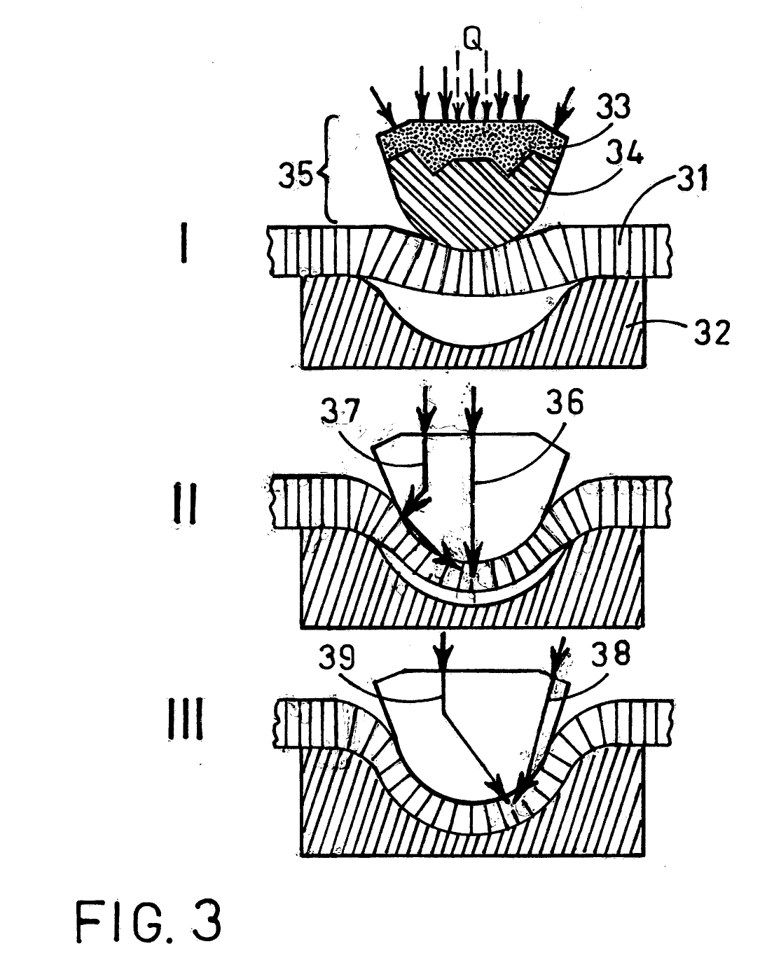

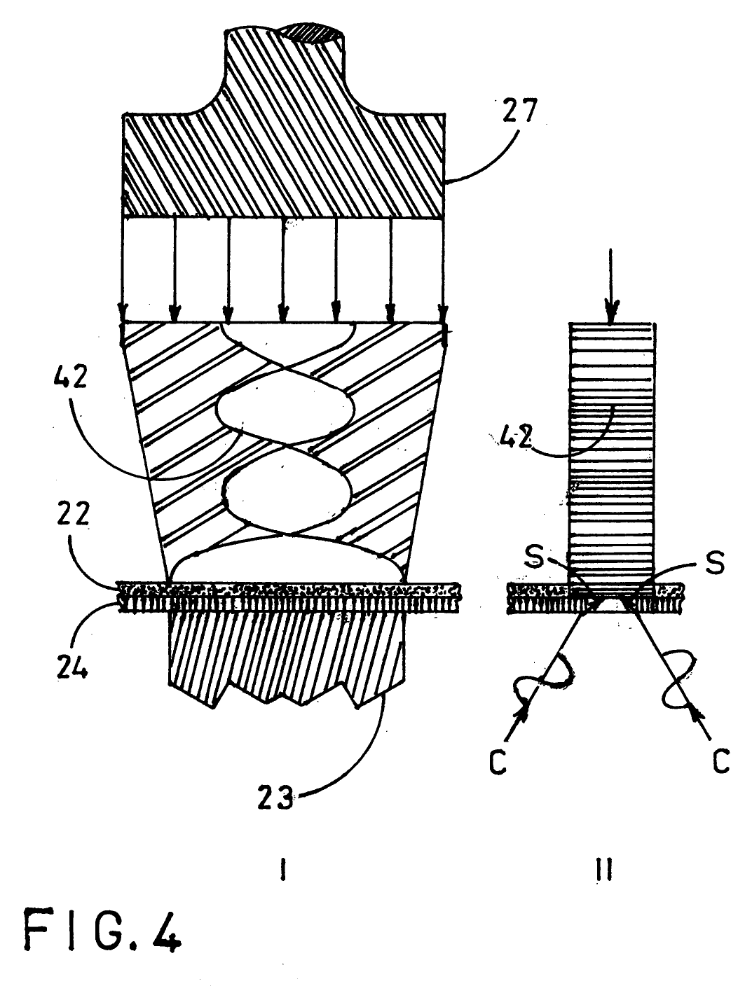

The apparatus and processes described in FIGS. 1 through 4 can be applied to fuse, modify material substructure, promote cohesion, and activate bonding agents for adhesion among workpiece elements, including metallics and nonmetallics.

The sonic lenses depicted i n FIGS. 1, 2, 3, and 4, and particularly the resonator depicted in FIG. 4, are specific examples of numerous possible configurations designed to induce shear mode impulses, coincident with compression mode impulses, in single or multi-element workpieces. Shear modes are derived from angular incidence of a compression impulses on the interface between: two contiguous dissimilar materials, the sonic lens, and the workpiece with each material exhibiting different inherent velocity of sonic wave propagation. Additionally, the sonic lenses and resonators are designed to impart phase or amplitude coherence of the shear and compression modes within the zone, or zones of wave mode superposition by selectively establishing impulse transit times from source-to-workpiece, through length of wavepath, resonance, and inherent shear and compression wave velocities of materials.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The invention in its first embodiment relates to solid state welding. Solid state welding is a group of welding processes which produce coalescence at temperatures essentially below the melting point of the base materials being joined, without the addition of brazing or filler materials. The oldest of these processes, forge welding, belongs to this group. Other processes include cold welding, diffusion bonding, explosion welding, friction welding, hot pressure welding, and ultrasonic welding. The exhibited apparatus and processing methodology differs from prior art in that:

Energy impulse sources may be selected from a number of forms such as: explosive charges or cartridges, mechanical impactors, single and multiple impact pneumatic sources, and electromagnetically impelled impactors. A sonic lens (or lenses) transforms compression wave impulses by refraction, accompanied by mode conversion and energy partition, into directed shear impulses, Said refraction is attained by selection of sonic lens material with sonic wave velocity having defined ratio to the sonic wave velocity in the workpiece. The shape and composition of said sonic lens are therefore, covariable.

Said sonic lens directs and superposes compression impulses to coincide with the shear impulses, to impinge on selected zones in the workpiece. This phenomenon is a spatial and temporal event where shear and compression impulses are simultaneous in time and space, characterized as phase or amplitude coherence. The sonic impulse transit time from the source to the selected zones in the workpiece is adjusted with lens shape and composition, and waveguides or delay lines a appropriate. Sonic filters or resonators, and impedance matching elements may be inserted along sonic wave paths to optimize power-spectral-densities and energy transfer. Sonic lenses may be positioned in arrays to attain desired sonic energy transfer configurations.

Specifically, the first embodiment of this invention improves on prior welding technology by:
A. Superposing shear and compression impulses of sufficient energy density and rate, in watts/square millimeter, to simultaneously drive metals in a workpiece from solid to viscoelastc state, and to dynamically forge contiguous elements within the workpiece by displacing cohesive inhibiting substances;
B. Combining plastic state and forging compression in metals, including dissimilar metals, to produce fusion, and fusing nonmetallic materials by activation of elements or agents at interfaces, or within the body of workpieces, or dispersion of adhesive inhibiting substances by exposure to superposed shear and compression impulses.

Primary advantages afforded by this invention, in contrast to prior art are:
C. Economy in energy consumption by concentrating energy at fusion interfaces;
D. Greater control in directing energy to fusion sites by sonic lens placement;
E. Flexibility in processing a wide range of workpiece shapes, mass and composition with options available in sonic lens designs and arrays;
F. Absence of deleterious metallic welding process residual effects, such as heat affected zones, alloy segregation, and residual stress;
G. Inherent ability to make ultrasonic nondestructive inspection an integral part of the process by monitoring ultrasonic spectral elements of the incident, transmitted and reflected impulses;
H. Safety factors accompanying the primary advantages are avoidance of thermal and optical flash hazards accompanying most conventional welding processes; and
I. Expenditure of consumables such as filler material is negated;

The invention in its second embodiment relates to forging, cold forming, and thermomechanical processing of metals. The oldest of these processes is blacksmithing, where metals are heated to induce plastic behavior and driven with repeated mechanical impulses to shape and form workpieces. The exhibited technique differs from the above prior art in that sonic shear impulse energy replaces thermal energy and sonic compression impulse energy replaces forging energy.

The present invention relates to metals thermomechanical processing by imparting sonic shear impulses to replace heat and imparting sonic compression impulses to replace conventional mechanical deformation. On a substructure scale, the sonic shear and sonic compression impulses drive dislocations in a highly controlled manner to transform metal properties. Primary advantages realized by the subject invention over prior art are:
J. More efficient use of energy through focusing and directing sonic shear and sonic compression impulses to desired zones in the workpiece;
K. Intrinsic energy interaction with materials, in contrast with indirect methods (e.g., heating materials from an external source) used in conventional hot forging and forming;
L. Safety and nondestructive inspection factors in this second embodiment are similar to those realized in the first embodiment;

A variant of the second embodiment of this invention is application of coincident or superposed shear and compression mode impulses to non-metallic materials to:
M. Effect cohesion among contiguous elements or laminae; and
N. Activate adhesive agents within or on surfaces of contiguous elements or laminae.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. An apparatus for sonic welding and materials forming comprising:
(a) a mechanical impulse source, sonically coupled to single or multiple sonic waveguide(s), delay line(s), resonator(s), impedance transformer(s), and lens(es) which superpose high-power-density sonic compression wave and shear wave impulses within the body of a workpiece;
(b) said mechanical impulse source generates high-power, single or multiple sonic compression wave impulses;
(c) said sonic lenses possess shape and composition attributes to focus sonic compression waves within the body of said workpiece;
(d) further, said sonic lenses possess shape and composition attributes to focus and mode convert sonic compression wave impulses into sonic shear wave impulses within the body of said workpiece; and
(e) said sonic wavegides, delay lines, resonators, and impedance transformers; which may be intrinsic to, or separate from the said workpiece, possess shape and composition attributes to direct and transmit sonic energy such that said sonic lenses superpose compression and shear impulses within the body of said workpiece.

2. The method of sonic welding of metallic materials with the apparatus defined in claim 1 wherein;
(a) sonic shear wave impulses, focused at the faying surfaces of a metallic workpiece consisting of two or more contiguous elements, transform all or part of said workpiece contiguous (faying surface) material from solid-to-viscoelastic state; and
(b) said sonic compression wave impulses, superposed on said shear induced viscoelastic material, fuse said contiguous metallic workpiece elements.

3. The method of metals forming with the apparatus defined in claim 1 wherein:
(a) said sonic shear wave impulses, focused within the body of a metallic workpiece, locally transform all or part of said metallic workpiece from solid-to-viscoelastic state; and
(b) said sonic compression wave impulses, superposed on said shear induced viscoelastic metal, dynamically forge said metallic workpiece into a desired shape.

4. The method of metallic materials substructure modification with the apparatus defined in claim 1 wherein:
(a) said sonic shear wave impulses, focused within the body of a metallic workpiece, locally transform all or part of said metallic workpiece from a solid-to-viscoelastic state; and
(b) said sonic compression wave impulses, superposed on said shear induced viscoelastic metal, modify metal substructure morphology;
(c) said substructure morphology modification in metals and their alloys be applied to relieve residual stress; and
(d) said substructure morphology modification in metals and their alloys be applied to selectively alter mechanical and physical properties.

5. The method of sonic welding of non-metallic materials with the apparatus defined in claim 1 wherein;
(a) sonic shear wave impulses, focused at the faying surfaces of said workpiece consisting of two or more contiguous elements, transform all or part of said workpiece contiguous (faying surface) material from solid-to-viscoelastic state; and
(b) said sonic compression wave impulses, superposed on said shear induced viscoelastic material, cohesively bond said contiguous workpiece elements.

6. The method of non-metallic materials forming with the apparatus defined in claim 1 wherein:
(a) said sonic shear wave impulses, focused within the body of said workpiece, locally transform all or part of said workpiece material from solid-to-viscoelastic state; and
(b) said sonic compression wave impulses, superposed on said shear induced viscoelastic material, displace said workpiece into a desired shape.

7. The method of both metallic and non-metallic materials adhesive activation with the apparatus defined in claim 1 wherein:
(a) said sonic shear wave impulses, focused on an adhesive agent between two or more metallic and non-metallic workpiece elements to locally introduce energy of adhesive activation; and
(b) said sonic comprression wave impulses, superposed on said activated adhesive agent, adhesively bond elements of said workpiece.

8. The method of non-metallic materials substructure modification with the apparatus defined in claim 1 wherein:
(a) said sonic shear wave impulses, focused within all or part of the body of said non-metallic workpiece, locally transform said non-metallic workpiece from a solid-to-viscoelastic state;
(b) said sonic compression wave impulses, superposed on said shear induced viscoelastic material, modify non-metallic material substructure morphology; and
(c) said substructure morphology modification be applied to selectively alter mechanical and physical properties of said non-metallic workpiece.
